(19) United States
(12) Patent Application Publication
(10) Pub. No.: US 2006/0077544 A1
(43) Pub. Date: Apr. 13, 2006

(54) Visual display screen arrangement

(75) Inventor: Bernard Harry Stark, Southhampton (GB)

Correspondence Address: WESTMAN CHAMPLIN & KELLY, P.A., SUITE 1400 - INTERNATIONAL CENTRE, 900 SECOND AVENUE SOUTH, MINNEAPOLIS, MN, 55402-3319, US

(73) Assignee: Seamless Display Limited, Southampton (GB)

(21) Appl. No.: 10/531,538

(22) PCT Filed: Oct. 14, 2003
(86) PCT No.: PCT/GB03/04461

§ 371 Date: Apr. 15, 2005

(30) Foreign Application Priority Data
Oct. 15, 2002 (GB) 0223883.0

(51) Int. Cl. G03B 21/56

(52) U.S. Cl. 359/448

(57) ABSTRACT

A visual display screen (100) has a display area (30), for displaying an image, and which extends as far as an optically inactive region (33) towards the edge of the display screen (100). A cover arrangement (400) overlays the display screen (100) and comprises a generally planar portion and an edge portion, comprising a light-bending region. The light-bending region is arranged to bend rays of light near the edge of the display screen (100) by means of refraction, reflection or diffraction such that the display area (30), as viewed externally of the arrangement, appears to extend substantially as far as the edge of the cover arrangement (400). The light-bending region further provides graded magnification, adapted to minimize the rate of change of local magnification across the cover arrangement (400). This function may be optimised for viewing across junctions between adjacent display screens (100, 100′).

The present invention relates to a visual display screen arrangement.

In many information-dependent activities, such as computing, trading, medical analysis and advertising, it is crucial to be able to display large amounts of data. There is an ever increasing demand for display systems having a larger display area, and also for systems which can display more information on a given display area or within confined spaces.

There are, however, a number of practical difficulties involved in manufacturing larger screens. For example, it is currently difficult and prohibitively expensive to produce Liquid Crystal Displays (LCDs) with diagonals exceeding about 75 cm (30″). In addition, a device or a display environment would often lose some of its functionality if a single, large display panel were used, such as in the case of pocket-sized electronic devices or a control panel in a cockpit.

Two different approaches have been taken to address the need for larger display arrangements.

Multiple-screen viewing systems generally consist of large tiled assemblies of display panels, which allow more information to be displayed for a given panel size. The individual panels may simultaneously display different types of data which are needed at the same time, such as with different applications windows. Portions of the same application window may be displayed on adjacent panels. In some cases, for example in advertisements or control rooms, a large image may be displayed over a multitude of panels, each panel displaying only a section of the overall image. The user is then able to view a large readable image of a sufficient size that eyestrain may be minimised.

Folding displays permit a comparatively large active screen area to be associated with small devices, without reducing their portability. The display is unfolded to provide a screen size which is larger than the outline dimensions of the device. Alternatively, the screen may have parallel screen sections which slide relative to each other. Example applications include portable computers, mobile phones, retracting displays and measurement devices, such as global positioning equipment.

Current display technologies generally produce individual display panels which have an inactive region around their periphery. The borders of such display panels may be narrowed to a certain extent; however, most modern and emerging display technologies, such as those relating to LCDs, electroluminescent displays, bi-stable displays, cathode ray tube displays, and others, usually require some form of encapsulation of an active display area, which results in an inactive border around each individual display panel. In the case of LCDs, for example, this border consists of a resin seal for containing the liquid crystal inside the display, electrical contacts and, in some cases, driver electronics. Normally, a metal edge surrounds the display, encapsulating the delicate edges of the LCD glass, electronics and edge of the back-light.

The inactive edge regions of display panels are a problem both for multiple-screen viewing systems and for folding displays, because the inactive edges of individual component panels form borders which separate the display, resulting in a segmented image. A two-panel folding display, for example, has two dark lines running though the centre of the display arrangement either side of the junction between the two panels, therefore making it difficult to read text across the join. Similarly, a large image displayed over a number of individual panels on a video wall has a number of strips missing from it. The inactive borders of individual panels prevent the user from being able to view the display as one continuous area.

WO-A1-02/42838 relates to a visual display screen arrangement which improves the edge viewing of display panels. An image to be displayed is compressed towards the periphery of each component panel. These compressed parts of the image are then optically stretched across the inactive edge regions by means of a lens which is laminated to the front of each display panel. The resulting viewed image is a nearly continuous image across joins and edges. In addition, a narrow strip of each individual panel image adjacent a junction between two panels may be repeated on the other side of that junction, thereby allowing off-axis viewing to a limited degree.

There are, however, a number of problems with the arrangement described in WO-A1-02/42838. In particular, the disclosed arrangement results in a relatively low resolution close to the edge of each display panel and also produces a distorted image as a viewer moves off-axis. In addition, there remains a thin dark line at the junction between the two panels.

It is therefore desirable to provide a visual display screen arrangement which improves the resolution near an edge of a display panel. It is also desirable to provide a visual display screen arrangement which minimises the distortion of an image as a viewer moves off-axis. It is further desirable to provide a visual display screen arrangement which reduces the appearance of the transition between adjacent display panels.

The present invention aims to address each of the above objectives by providing an improved visual display screen arrangement.

According to the present invention, there is provided a visual display screen arrangement for displaying an image, comprising image display means having a display area, and a translucent cover member arranged to cover the display area and having a first cover member edge, the display area having an edge extending towards but not as far as the said first cover member edge, the cover member providing a local magnification defined as the ratio of the apparent magnitude of an area A of the display area, as viewed through the cover member at a particular angle of incidence, to the actual magnitude of that area A within the display area, the cover member having (a) a generally planar portion covering at least a part of the display area and being arranged to transmit parallel rays of light emanating from different locations across the display area such that they are bent by substantially the same angle when viewed externally of the arrangement and wherein the local magnification is substantially unity, and (b) an edge portion which includes the first cover member edge, the said edge portion having a light bending region arranged to bend rays of light emanating from different locations at or adjacent to the edge of the display area such that the said display area, as viewed externally of the arrangement and through the edge portion, appears to extend substantially as far as the edge of the cover member, wherein the light bending region of the edge portion provides a local magnification which varies with distance from the cover member edge, and wherein the light bending region has a graded magnification adapted to minimize the rate of change of local magnification between the generally planar portion of the cover member and the first cover member edge.

Grading the magnification between the planar part of the cover member and the cover member edge reduces the distortion which is a result of large gradients in the local magnification. This stops or at least minimises the problem of image ‘floating’ around the edge, wherein, as the eye moves from side to side, the apparent magnification of a given pixel, for example, in the display area, changes. It is this floating that represents an apparent distortion to a viewer.

Preferably, the integral of the local magnification over the arrangement is maximised, by increasing the width of the light bending region relative to prior art arrangements. The integral of the local magnification determines the width of the display area.

In a preferred feature of the present invention, a surface extending between a point on the cover member edge and the edge of the display area may comprise a reflective surface. The reflective surface may be arranged to reflect light received from the display area, such that the appearance of a seam at the edge of the display panel may be reduced at off-axis viewing positions. Indeed, in applications, for example, which involve low-resolution viewing, the reflective surface may be used without image magnification towards the edge of the cover member and this represents a further aspect of the present invention.

In one advantageous feature of the present invention, having two, adjacent image display means, there is provided a single cover member, which extends across both the edge of the display area of the first image display means and the edge of the display area of the adjacent image display means. Preferably, the cover member does not extend fully across both image display means. This feature represents a further aspect of the present invention, and finds particular application in angled desktop displays.

Other preferred features are set out in the dependent claims which are appended hereto.

The present invention may be put into practice in a number of ways and some embodiments will now be described, by way of example only, with reference to the following figures, in which:

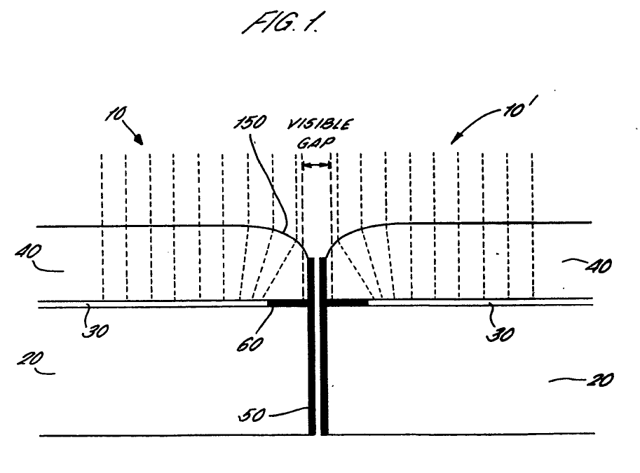

FIG. 1 shows, schematically, a section through an LCD display panel 10 in accordance with the prior art and having an active display region and cover member;

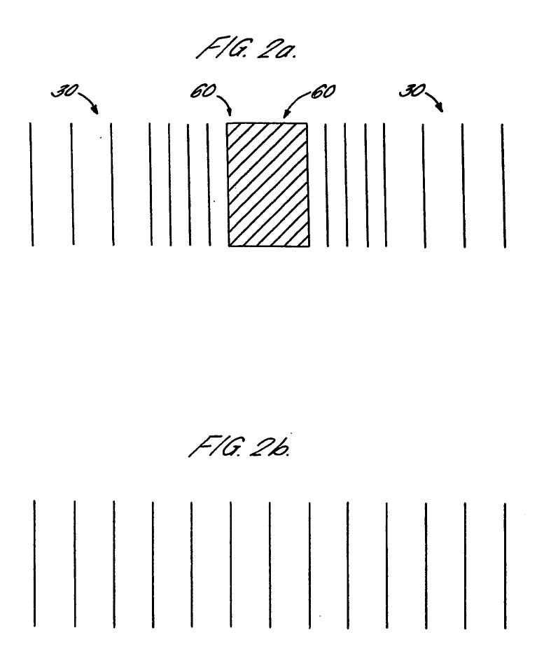

FIG. 2a shows a highly schematic top view of an image comprised of an array of parallel lines, as displayed within the active display region of the display panel of FIG. 1;

FIG. 2b shows schematically the generated image of FIG. 2a, as seen through the cover member when viewed orthogonally;

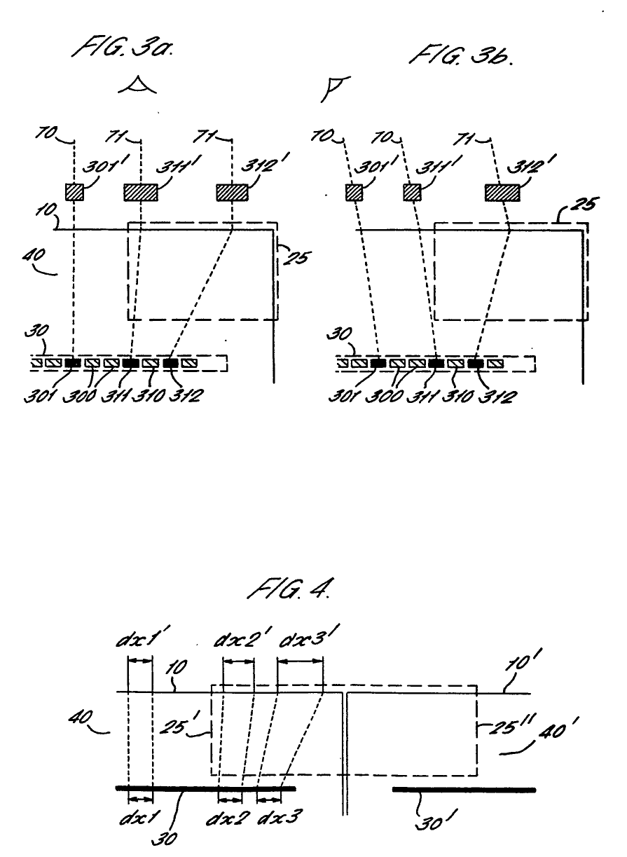

FIGS. 3a and 3b show highly schematic sectional views of the panel edge of the prior art arrangement of FIG. 1, showing the apparent magnification of the pixels when viewed orthogonal to and off axis of the cover member respectively;

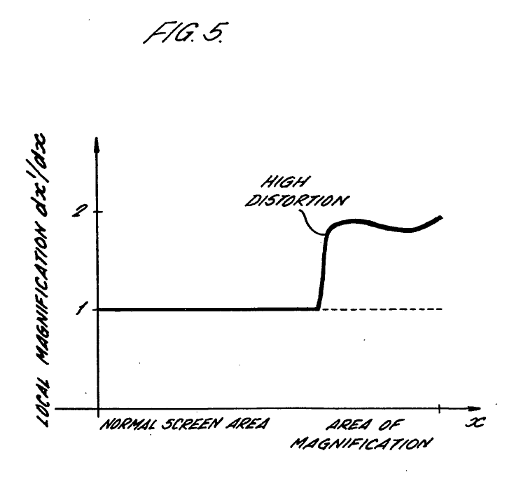

FIG. 4 shows a schematic section of the edge of the panel of FIGS. 1, 2a and 3b, illustrating the concept of local magnification;

FIG. 5 shows a graph of local magnification as a function of the perpendicular distance to the cover member edge, for the prior art arrangement of FIGS. 1 to 4;

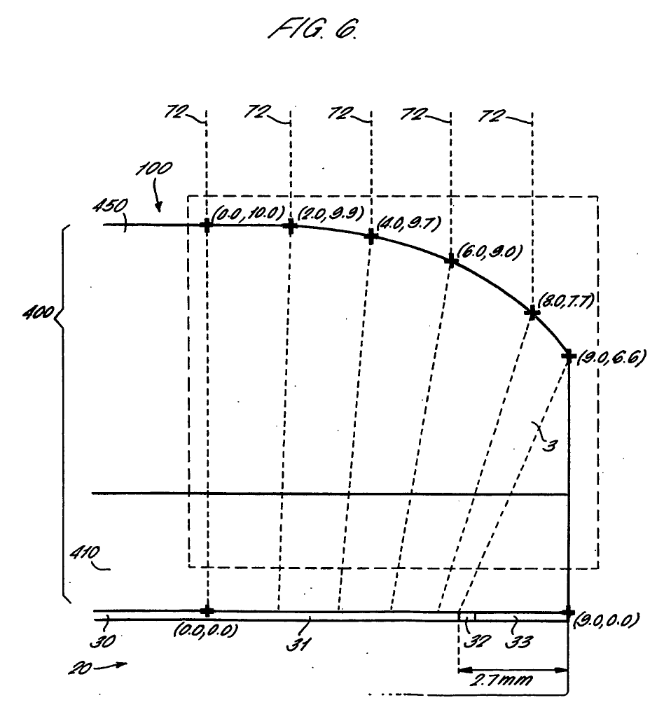

FIG. 6 shows a schematic sectional view of an LCD panel embodying the present invention including a laminar cover plate having a curved edge drawn broadly to scale and providing for graded compression;

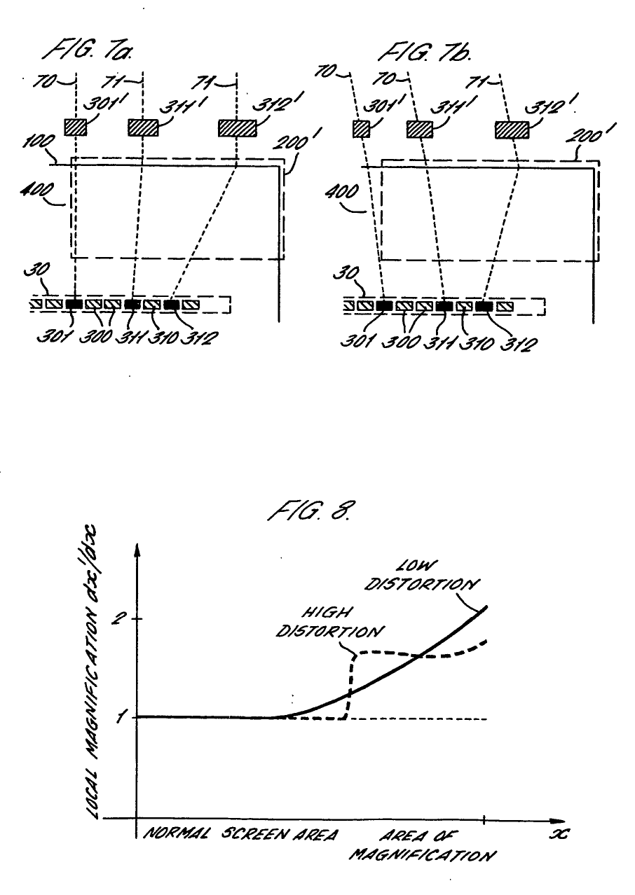

FIGS. 7a and 7b show a schematic sectional view of the panel of FIG. 6, illustrating the effect of the graded compression of FIG. 6 when viewed normally to and at an acute angle to the planar surface of the cover plate thereof, respectively;

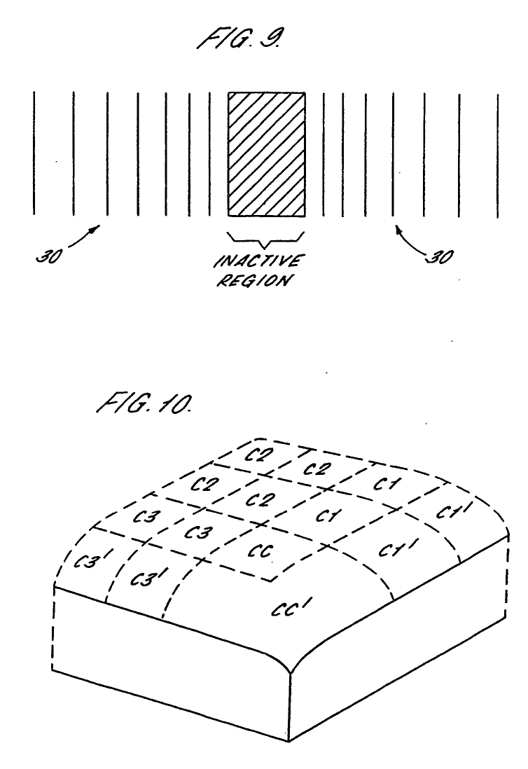

FIG. 8 shows a graph of local magnification as a function of the perpendicular distance to the cover member edge, for the arrangements of both FIG. 6 and FIG. 1;

FIG. 9 shows a highly schematic top view of an image comprised of an array of parallel lines as displayed within the active display region of the display panel of FIG. 6;

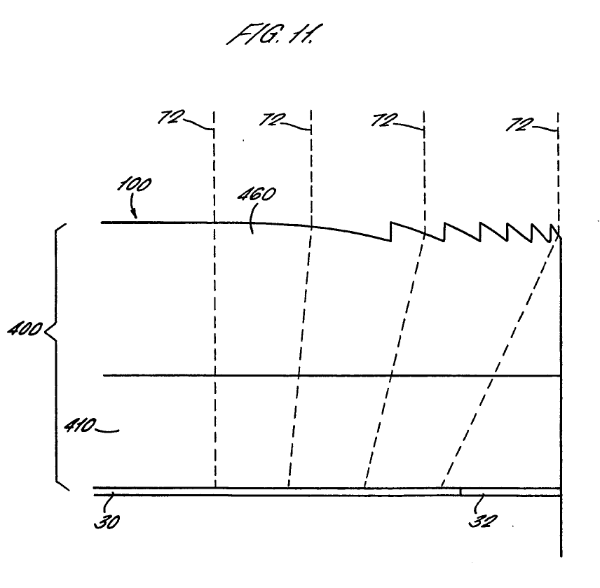

FIG. 10 shows, in a highly schematic form, a perspective view of a corner of the cover plate of FIG. 6, and suitable for joining multiple panels in two orthogonal directions;

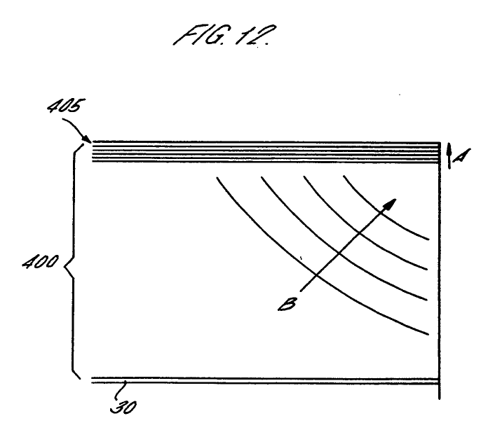

FIG. 11 shows a sectional view of an LCD panel in accordance with a second embodiment of the present invention which uses a segmented lens;

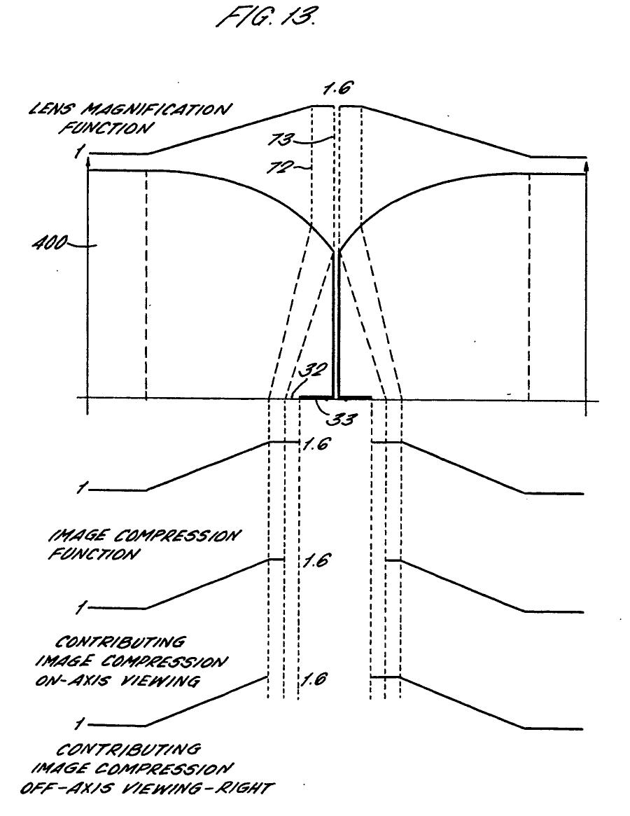

FIG. 12 shows a schematic sectional view of an LCD panel in accordance with a third embodiment of the present invention and which includes a cover member having a graded refractive index;

FIG. 13 shows a sectional view of an LCD panel in accordance with a fourth embodiment of the present invention and which illustrates edge-adjusted lens magnification and image compression functions;

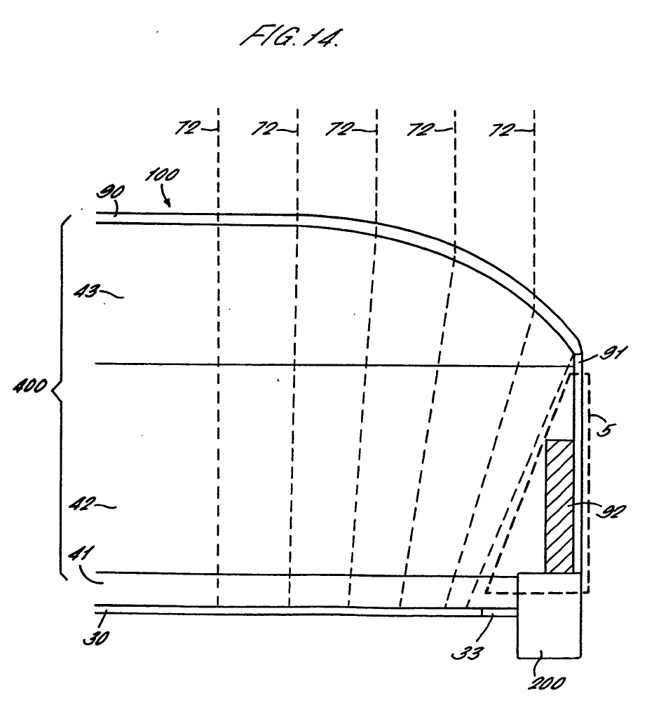

FIG. 14 shows a sectional view of an LCD panel in accordance with a fifth embodiment of the present invention and which includes a curved functional layer laminated to the cover member;

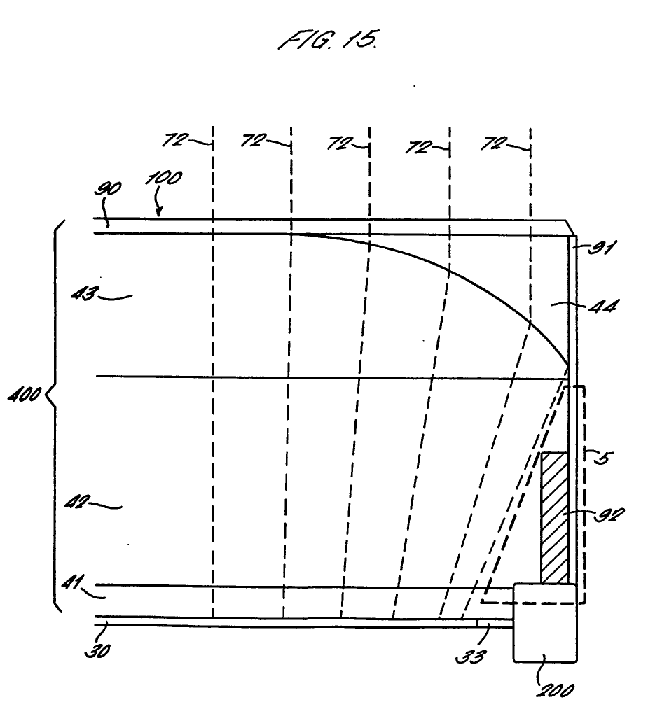

FIG. 15 shows a sectional view of an LCD panel in accordance with a sixth embodiment, similar to the third embodiment of FIG. 12, but wherein the functional layer is planar;

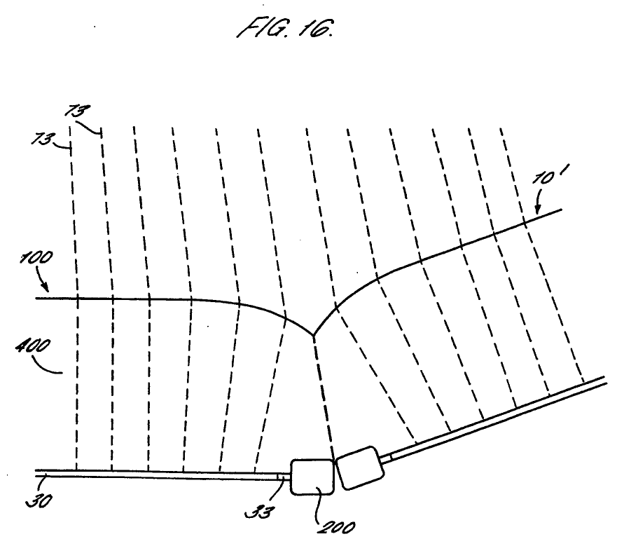

FIG. 16 shows a highly schematic sectional view of an LCD panel in accordance with a seventh embodiment of the present invention and having two abutting and bevelled display panels;

FIG. 17 shows a schematic sectional view of a panel edge, illustrating an imageless strip beyond a certain off-axis viewing angle;

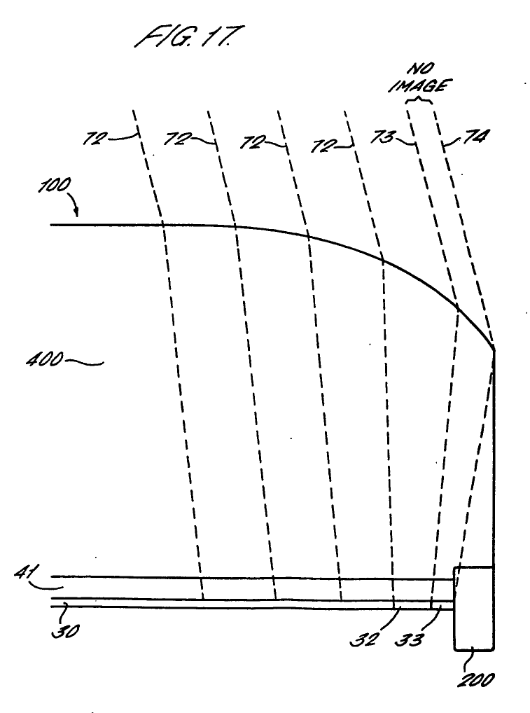

FIG. 18 shows a schematic sectional view of a panel edge in accordance with a further embodiment of the present invention, including a reflective surface at the interface between the active and inactive regions of the panel;

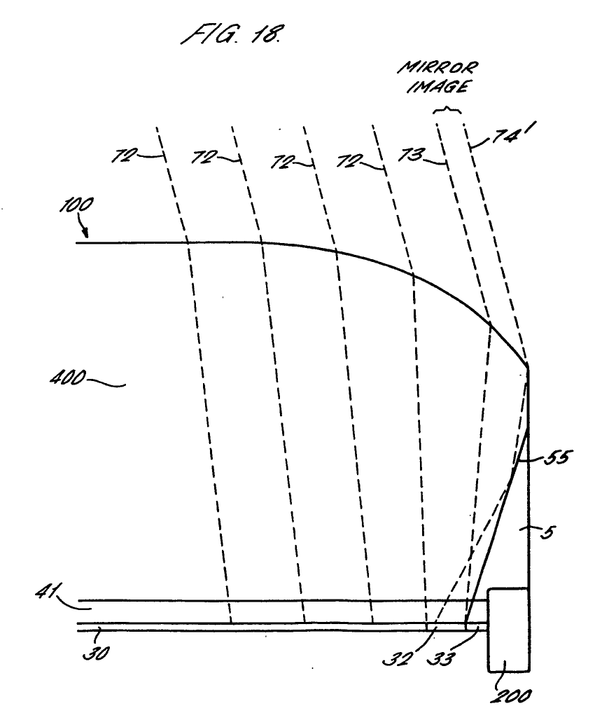

FIG. 19 shows a schematic sectional view of a panel edge of the embodiment of FIG. 18 and having a reduced cover arrangement thickness;

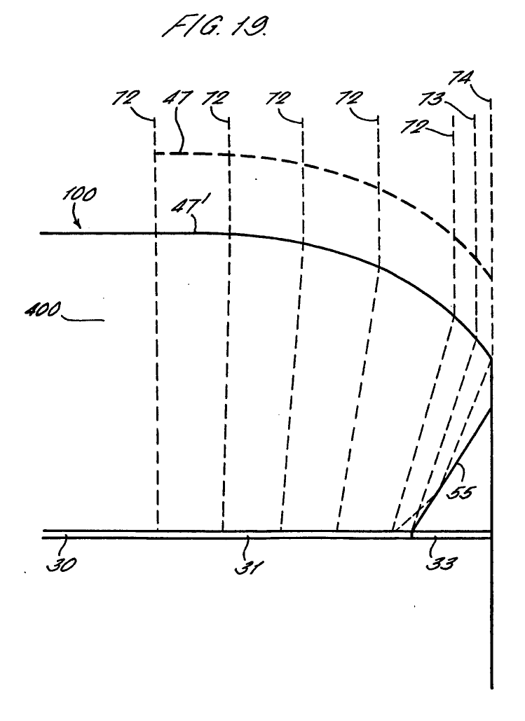

FIG. 20 shows a sectional view of a panel edge in accordance with a further feature of the present invention, which does not include a magnifying portion, but which employs the reflective interface only;

FIG. 21 shows, highly schematically, a sectional view of a panel edge embodying a further preferred feature of the present invention, including optical compression and optical reduction of the appearance of a seam;

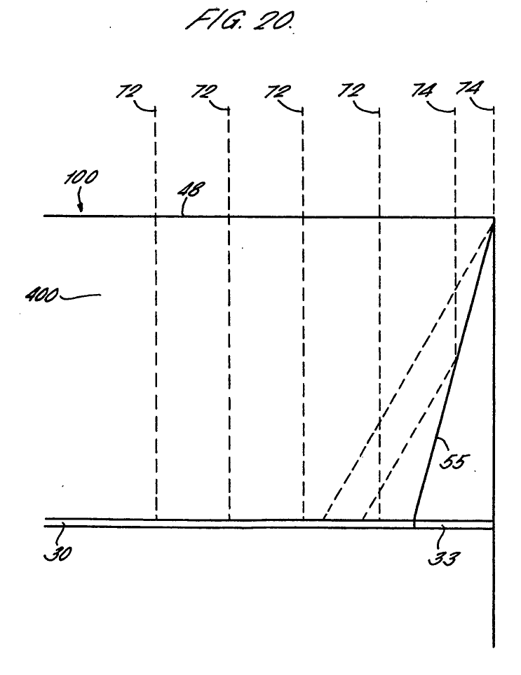

FIG. 22 shows a sectional view of a panel edge illustrating an alternative embodiment of the optical compression arrangement shown in FIG. 21;

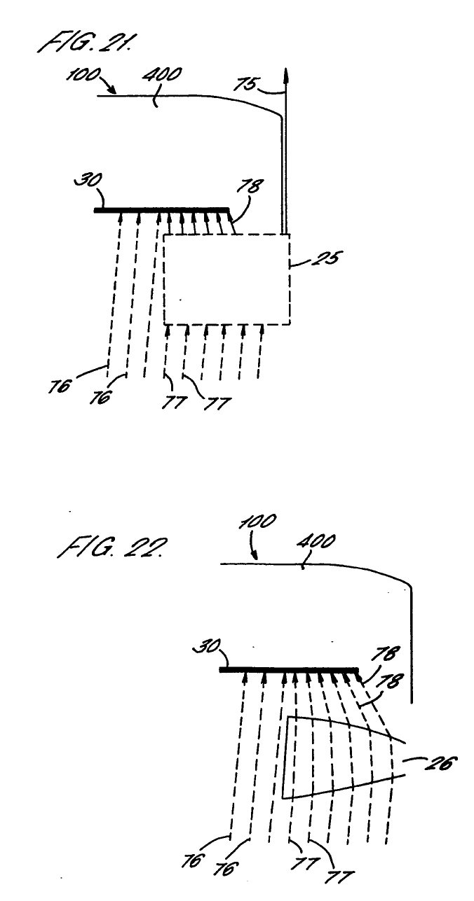

FIG. 23 shows, highly schematically, a sectional view of two abutting LCD display panels in accordance with still a further preferred feature of the present invention and wherein unused display light is coupled into the seam to reduce its appearance;

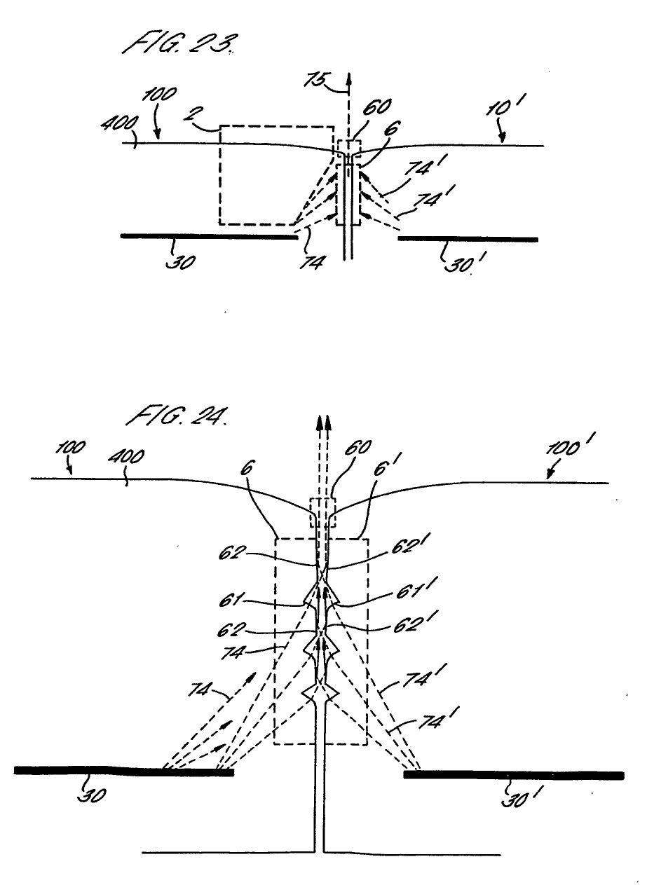

FIG. 24 shows one particular embodiment of the light-coupling region of FIG. 23 in close-up view;

FIG. 25 shows a perspective exploded view of a display panel embodying the present invention;

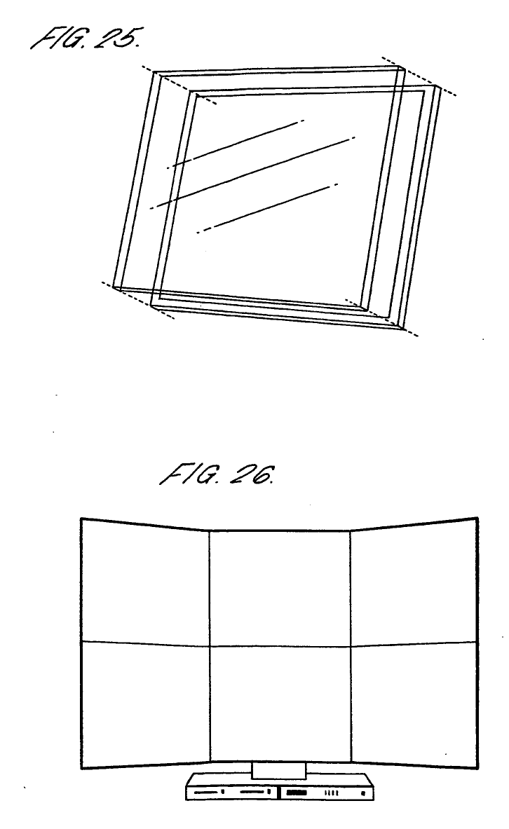

FIG. 26 shows a front perspective view of a multiple-screen viewing system implementing embodiments of the present invention;

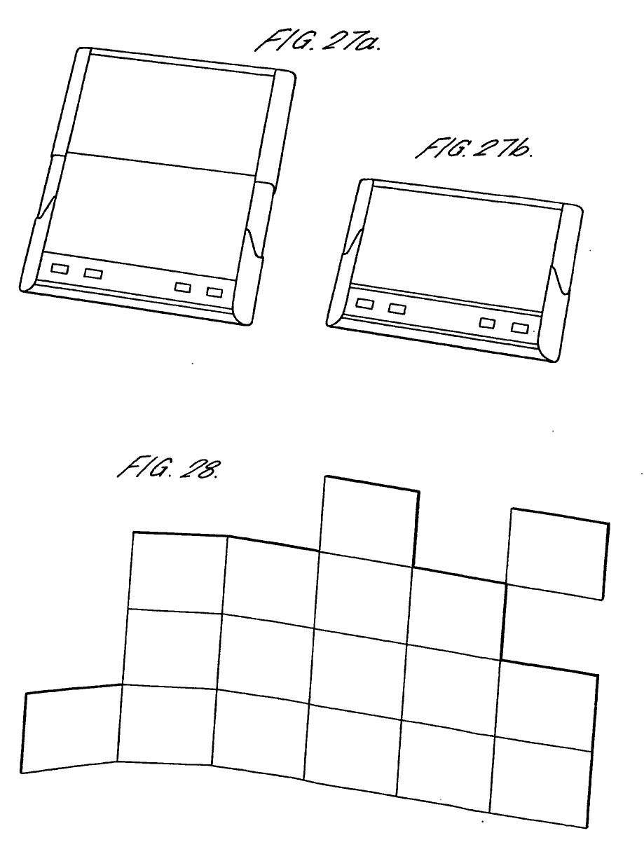

FIGS. 27a and 27b show perspective views of a further implementation of the present invention, in an open and closed configuration respectively;

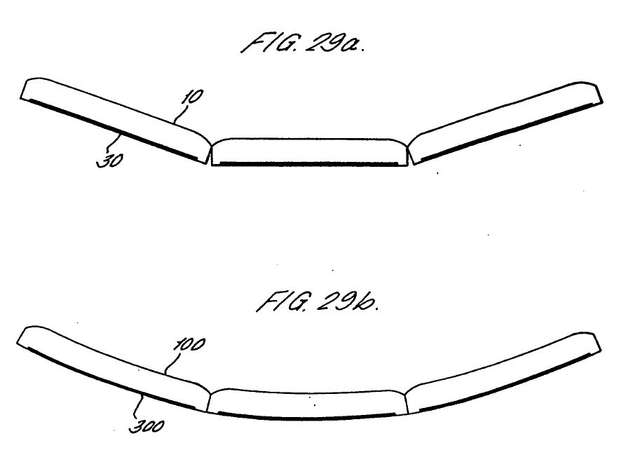

FIG. 28 shows a perspective view of a multiple-screen implementation embodying the present invention;

FIGS. 29a and 29b show further embodiments of the present invention forming non-planar displays, either with rigid, curved or flexible displays;

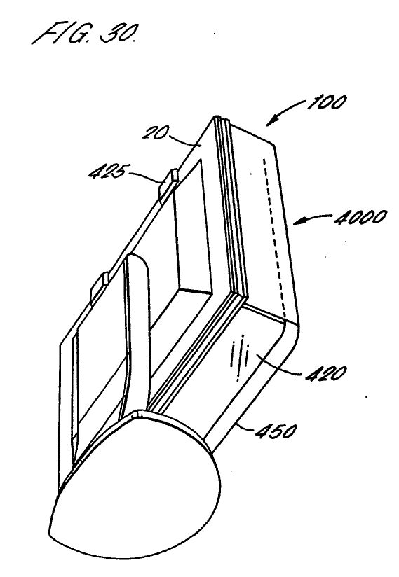

FIG. 30 shows a perspective view of a modular display monitor implementing embodiments of the present invention;

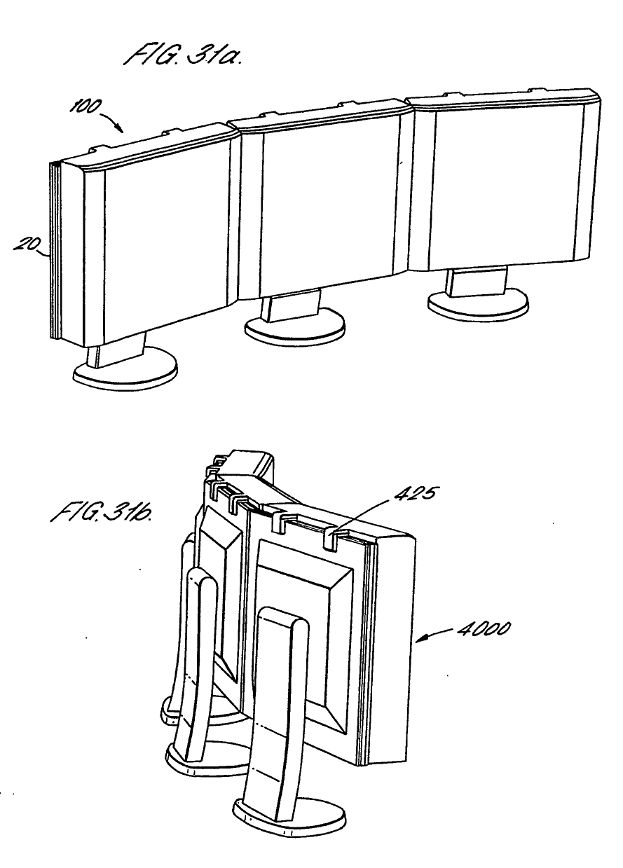

FIGS. 31a and 31b show perspective views of an array of the modular display monitor of FIG. 30;

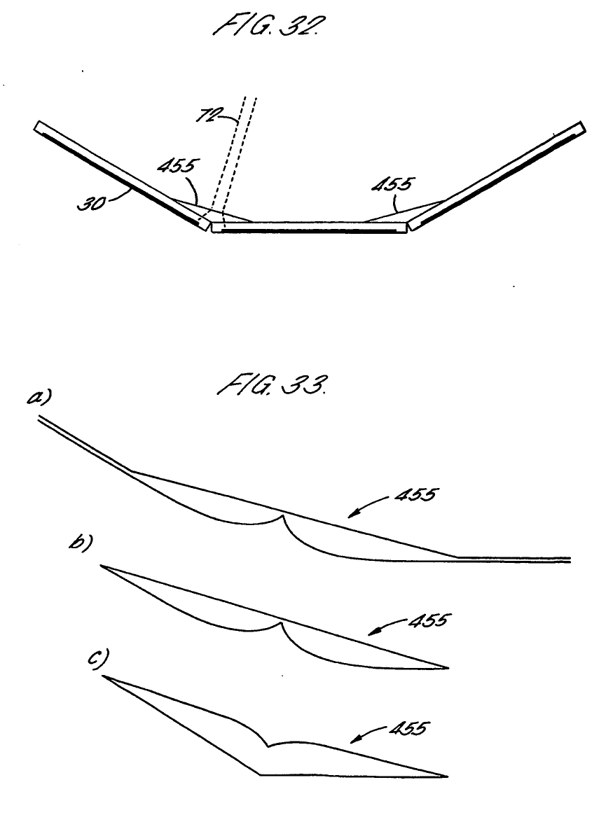

FIG. 32 shows an angled panel arrangement in accordance with a further feature of the present invention, in which a single lens layer extends across the edges of adjacent displays; and

FIG. 33 shows exemplary adaptations of the lens layer of FIG. 32, which either partially or fully cover the adjacent display.

Referring first to FIG. 1, a highly schematic section through the edge of two liquid crystal display panels 10, 10′, in accordance with the arrangements of WO-A1-02/42838, is shown. Each LCD panel comprises a supporting substrate 20 (typically including a reflector, first glass plate, first polarizing element and a back light, but none of which is shown in FIG. 1 for the sake of clarity). A glass cover arrangement 40 is mounted over the supporting substrate 20. Sandwiched between the supporting substrate and the glass cover arrangement 40 is a volume which forms an active display region 30. The active display region 30 contains a plurality of electrodes (not shown), as will be familiar to those skilled in the art, together with liquid crystals (also not shown).

The panels 10, 10′ may be bounded by side walls 50 which provide mechanical protection to the panel. The liquid crystals are contained within the active display region 30 also by an epoxy edge seal 60 which typically has a protective layer thereon. In consequence of this, there is a region adjacent to the edge of the LCD panel which cannot produce an image. This inactive region formed by the edge seal 60 is in present LCD panels typically between 1 and 1.5 mm wide. As explained in the above-referenced WO-A1-02/42838, by providing a curved edge to the cover arrangement 40, an image displayed within the display region 30 may be optically “stretched” so as to provide an image that appears to extend right to the edge of each panel as viewed from above.

To address the magnifying effect of the curved edge, the actual image formed within the active display region 30 is, as disclosed in WO-A1-02/42838, preferably compressed at the edge of the active display region 30 adjacent to the inactive region formed by the edge seal 60. This is shown in FIG. 2a, which shows a highly schematic plan view of the active and inactive regions 30, 60 of two panels 10, 10′ placed adjacent to one another, but without the refracting or light-bending components of a cover arrangement 40. The series of parallel lines is shown, with a compressed spacing adjacent each inactive region. When the cover arrangements 40 are placed over each panel 10, 10′, the light bending components of these cause the parallel lines adjacent to the inactive regions to be magnified and shifted sideways. This is shown (again schematically) in FIG. 2b.

As explained above, a problem with the arrangement shown in FIGS. 1 and 2 is that the apparent image has a low resolution near the join. This is because the lens formed by the curved edge spreads a relatively narrow strip of the image (adjacent the edge of the active region 30) over a large area in order to “mask” the inactive regions.

Moreover, when a viewer moves off axis and no longer views the image in the active display region 30 from a position generally normal to the cover arrangement 40 through the edge thereof, the image becomes severely distorted. This can result in loss or misinterpretation of displayed information.

The reason for this distortion is related to the fact that, as the viewer moves between on-axis and off-axis positions, the portion of the cover member through which he observes any one pixel may change. The problem occurs particularly (but, as will be understood from subsequent Figures, by no means exclusively) in the transition region of the cover member where the curved, edge region joins the planar region. At this point, the viewer may view a pixel first through the planar region and then, on changing position, through the curved, edge region. The apparent image of this particular pixel therefore varies from approximately its actual size to a magnified size, the part of the image generated by this pixel therefore becoming distorted.

In general, in order to produce an undistorted image when viewed on-axis, the image compression of each individual pixel must roughly equal its optical magnification, thereby restoring the original image. The reason for this off-axis distortion is related to the fact that, as the viewer moves from on-axis to off-axis positions, the portion of the cover member through which he observes any one pixel may change. Therefore, although the image compression of a particular pixel remains the same, the magnification is determined by the new portion of the cover member. Consequently, a spatial variation of magnification can result in distortion. The higher this spatial variation is (in other words: the higher the gradient of the local magnification is), the higher the distortion of the apparent image becomes when viewed off-axis. In WO-A1-02/42838 the problem occurs particularly in the transition region of the cover member, where the curved, edge region joins the planar region, because the gradient of magnification here is very high, due to the magnification being close to a step function.

The specific problem of distortion when it appears at or around the transition can best be understood by reference to FIGS. 3a and 3b. These Figures show, in highly schematic fashion, the edge of a display panel 10 having a light bending region 25 which is in accordance with the prior art and WO-A1-02/42838 in particular. For example, the light-bending region 25 may be a curved edge. The display panel 10 is also shown with an active display region 30 containing individual pixels 300, 301, 310, 311 and 312. FIG. 3A shows the appearance of these pixels when viewed through the panel 10 at a viewing angle which is substantially normal to the planar part of the cover arrangement 40. FIG. 3b shows the same pixels viewed at an angle to that planar surface.

In FIG. 3a, a viewer sees light from pixel 301 which has passed through the planar part of the cover arrangement 40 and so does not appear to be magnified. The apparent pixel image 301′ is, in other words, essentially unmagnified. However, because light from pixels 311 and 312 passes through the light-bending region 25, which acts as a lens, these pixels appear magnified as may be seen by apparent pixels 311′ and 312′.

The problem with this is seen from FIG. 3b which illustrates the most extreme case, where a given pixel can go from zero magnification to a maximum as a viewer's head moves relative to the panel. When viewed off-axis, light emanating from pixel 311 which would be subject to magnification by the light-bending region 25 were it viewed perpendicularly to the planar surface of the cover arrangement 40, is instead not magnified. In other words, the size of apparent image 301′, arising from pixel 301, is broadly the same as that of apparent image 311′ arising from pixel 311. Since the image that is displayed on pixel 311 corresponds to a compressed section of the overall image, then if it is viewed through a non-magnifying section of cover arrangement 40, this region of the image appears distorted.

In order further to explain this, and to allow an explanation of the principles underlying the present invention, reference is now made to FIG. 4 which shows, again schematically, a section through the panels 10, 10′ of WO-A1-02/42838. The active display regions 30, 30′, the cover members 40, 401, and the light-bending regions 25, 25′, which typically have curved edges, are shown. “Local magnification” is defined as a ratio of the apparent width of a pixel as seen by a viewer, to its real width in the active display region 30, in a direction perpendicular to the junction between the two panels 10, 10′ in the present case. For example, with a high resolution LCD display, an area A may be chosen to correspond with a pixel. However, it is to be stressed that the area A and the width x are essentially definable arbitrarily. In other words, the local magnification function maps a suitably small strip, of width dx, of the active area onto its apparent image, of width dx′ as illustrated schematically in FIG. 4 by the guide lines 3, which are not equivalent to the light rays. As can be seen from the Figure, the local magnification of panel 10 increases towards its edge. As seen in FIG. 5, however, a plot of local magnification dx′/dx against distance from the edge of the panel 10, has a significant step or knee in it, at the transition between the normal, planar viewing region and the light-bending region 25. This results in distortion which is highly dependent upon viewing angle. Again, it is to be stressed that this ‘knee’ is a ′ consequence of the particular light bending properties of the cover assembly of FIG. 1 and that the local magnification may vary in different ways as a function of distance. It is the rate of change of local magnification with distance that tends to determine the distortion.

Referring now to FIG. 6, a section through a display panel 100 is shown and which represents a first embodiment of the present invention. The panel 100 comprises a supporting substrate 20 which again may include a reflector, first glass plate, first polarizing element and a back light, as is usual for liquid crystal displays, but which features are again not displayed since they do not form a part of the present invention and would obscure an explanation thereof.

There is likewise an active display region 30 containing a plurality of electrodes (not shown) together with liquid crystals, mounted above the supporting substrate 20. An inactive region 33 is once more provided. Above the active display region 30 and the inactive region 33 is provided a cover arrangement 400 which, in the preferred embodiment of FIG. 6, includes a first, lower part forming a display cover member 410, and a second, upper part forming a lens 450.

The lens is in preference composed of material with a high index of refraction and low dispersion. The specific exemplary arrangement of FIG. 6 is designed for use with a polycarbonate material; however, the lens may be formed of any suitable material (such as glass) as will be appreciated by those skilled in the art. The layered arrangement of FIG. 6 which includes a display cover member 410 and lens 450 is particularly beneficial since it allows for a composite structure to be formed from a “standard” liquid crystal display having a planar cover member. The lens 450, being in preference formed of a polycarbonate material in the embodiment of FIG. 6, can be relatively lightweight such that the overall weight of the panel 10 is not increased unacceptably relative to prior art panels. A further advantage of the laminar arrangement of FIG. 6 is that functional layers, such as optical films for example, can be incorporated as well. In order to reduce variations in the viewed image quality, any laminate materials should have compatible temperature coefficients of expansion.

The lens 450 has a generally planar part away from the edge of the panel 100 and is generally curved towards the edge. In contrast to the arrangement of the prior art, however, the edge does not have uniform curvature. The shape of the edge of the lens 450 in this case reduces the rate of change of local magnification across the lens in thus removing the knee as seen in FIG. 5. This in turn reduces the distortion as seen by a viewer.

Specific but merely exemplary x, y coordinates for the lens 450 are shown in FIG. 6. The origin (0, 0) is defined upon the active display region 30, vertically below the point upon the surface of the lens 450 where the radius of curvature becomes finite. (x, y) coordinates, in millimetres, are shown for the purposes of illustration only in FIG. 6, and the non-zero rate of change radius of curvature of the lens edge will be noted which in the embodiment of FIG. 6 is what reduces the rate of change of local magnification with distance relative to the prior art, reduces and hence what reduces the distortion. The exemplary dimensions of FIG. 6 allow for a region with a width of 2.7 mm to be hidden. This includes the repeated region.

The active display region 30 of the panel 100 also includes a compressed region 31 and a repeated image region 32 which are analogous to, but modified from, the compressed and repeated image regions of the arrangement of WO-A1-02/42838. These will be described further below.

It will be noted that the coordinates shown in FIG. 6 require the display cover member 410, in the present example including glass, to have a similar refractive index to that of the lens 450 which is preferably of polycarbonate material in this case other shapes may be desirable in particular where other refractive arrangements are employed. Specifically, it will be understood that it is the rate of change of local magnification that determines the distortion. This may in turn be determined by the shape of the lens 450 but may as well or instead be a consequence of lens thickness, variation in refractive index, or other features.

FIGS. 7a and 7b show the effect of a gradually increasing local magnification such as is provided by the arrangement of FIG. 6. FIGS. 7a and 7b are similar to FIGS. 3a and 3b and thus are labelled with like reference numerals, save that the light-bending regions 200′ in FIGS. 7a and 7b include the gradually increasing local magnification such as may be provided, for example, by the geometry shown in FIG. 6.

It will be seen from FIG. 7a that the consequence of a gradual increase from unity to a maximum in the local magnification towards the cover member edge is a corresponding gradual increase in the magnification of the apparent pixel images 301′, 311′ and 312′ relative to the actual pixel sizes of pixels 301, 311 and 312 respectively. As the viewer moves off axis and views the panel at an angle, illustrated in FIG. 7b, the light rays (schematically illustrated by dotted lines 70 and 71) of individual pixels pass through regions of slightly lower local magnification with the result that the apparent images in FIG. 7b are slightly narrower than those of FIG. 7a. However, this small variation provides for a smaller overall distortion in the viewed image, in comparison with the prior art arrangements.

It will thus be understood that, for a given width of inactive area, increasing the extent of the magnifying edge portion of the lens 450 (FIG. 6) permits the average local magnification of the cover arrangement 400 to be reduced. Consequently, the gradient of the local magnification may also be smaller, thus permitting off-axis distortion to be reduced even further. In addition, the reduced average local magnification would result in a smaller drop in resolution towards the edge of the cover arrangement 400. Referring now to FIG. 8, a plot of local magnification dx′/dx as a function of distance x from the edge of the panel 100 of FIG. 6 is shown. The local magnification as a function of distance for the prior art arrangement (that is, the function shown in FIG. 4) is also shown in FIG. 8 as a broken line for the purposes of comparison. It will be seen that, whilst the local magnification at the edge of the lens 450 is slightly greater than the local magnification of the prior art arrangement, importantly the maximum rate of change of the local magnification as a function of distance is much lower for the arrangement of FIG. 6 than for the arrangement of the prior art because the magnification does not include a knee or step.

Since the local magnification of the cover arrangement 400 in the present invention is not described by a step function, the magnification may be described as “graded magnification”. This means that the transition from the local magnification being unity in the main, planar cover portion, to the local magnification achieving a maximum value moving towards the cover member edge, in the edge portion, is substantially continuous and takes place over a relatively large region. For example, in pixellated displays, the magnification may increase from pixel to pixel, over a significant number of pixels, although other ways of achieving this are intended and will be readily apparent to the skilled person.

It will be understood that the gradient of the local magnification is responsible for the amount of distortion which is produced by the display panel 100, and that the integral of the local magnification over the width of the magnifying, edge portion gives the maximum allowable inactive area. Therefore, the desirable magnification function has an approximately constant and relatively low gradient in order to achieve low distortion, and extends further into the cover arrangement 400 in order to accommodate a relatively wide inactive area. The distortion at off-axis viewing angles is dramatically reduced, since discontinuities in the bending of rays emanating from the same pixel at and around the transition between the planar portion and the edge portion are minimised to the extent that they are substantially imperceptible.

In accordance with another preferred feature of the present invention, the quality of the viewed image may be further enhanced by compressing the part of the displayed image near the edge of the active display region 30 gradually, rather than uniformly. In this way, the increasing image magnification resulting from the geometry of the lens in the light-bending region 200 (in this example) is complemented by graded compression of the display image, so that the viewed image appears even more uniform and substantially without distortion. The compression of the image to be displayed by the active region may be arranged to compensate for the varying magnification, at the edge of the lens 450 so that, to a substantial extent, the viewed image does not include parts which appear to have been magnified by different amounts. In FIG. 2a, it is seen that the spacing between parallel lines is compressed, but uniformly, adjacent the inactive region in the arrangement of WO-A1-02/42838.

Referring to FIG. 9, an arrangement of parallel lines is shown to illustrate the compression of an image when a cover arrangement 400 such as is shown in FIG. 6 is employed. It will be seen that the parallel lines, whilst equidistantly spaced away from the edge of the panel 100, are compressed by different and increasing amounts as they move towards the edge of the panel 100.

In an embodiment in which more than two panels are joined to form a large display, a panel 100 may require edge portions along more than just one side. A two-by-two display, for example, requires a horizontal and a vertical side on each of the four screens to bend light rays. Preferably, the corner of an individual panel 100, at which the two edge portions meet, magnifies the respective corner of the active display area 30 so that the corner part of the image extends into the corner of the inactive border of this panel. In this region, the magnification is graded in two dimensions to avoid image distortion at the corners of each panel 100, which together form the centre of the two-by-two display. Along an edge of a panel, the lens shape may be described as a two-dimensional section which is uniformly extended in a direction parallel to that edge. At the corner, however, the three-dimensional intersection of the respective edge sections would produce a ridge (similar to the corner of a picture frame) which does not have the desired ray-bending properties. It is preferable, therefore, to form the corners of the cover members by the intersection of a cylindrically symmetric magnifying lens and a rectangular plate, or any other suitable shape.

FIG. 10 shows, in a highly schematic way, the currently preferred shape of a corner of a panel 100 which includes two or more edges having a magnifying, edge portion. The cover arrangement 400 may be divided into several sections for this purpose. The main area of the cover arrangement 400 consists of regions C2, in which the image generated on the active display area 30 is not magnified for the viewer. The edge regions C1 and C3, located over the active area 30, are formed by parts of the cover member lenses, and the displayed images in these regions are stretched over the inactive regions 32 and extend across areas C1, C1′ and C3, C3′ respectively. Finally, the part of the displayed image in the active area 30 below the cover member corner CC is stretched in two directions, to extend across area CC′. The shape for this corner section CC and CC′ may, for example, be partly formed by rotating the two-dimensional lens profile about the vertical axis through the origin in FIG. 6. The resulting corner object must then be extended, however, to obtain the full corner geometry, which has a rectangular top profile. With such a corner geometry, the compression at or near the corner of the cover arrangement 400 is preferably increased to improve the apparent image. Alternatively, radial cross-sections with reduced magnification may be employed, thereby allowing the typical edge compression to be extended into the corners. In order to permit off-axis viewing in any direction with such a two-by-two display, the repeated image region 32 at each corner of the active area 30 preferably contains a part of the image from the diagonally-opposing panel 100.

FIG. 11 shows an alternative embodiment of the present invention, in which the edge portion of the cover arrangement 400 includes a segmented, or Fresnel, lens 460. The lens 460 offers an alternative to the essentially geometric solution of FIG. 6, and changes local magnification as a function of distance are reduced by the arrangement of Fresnel lenses as exemplified by FIG. 11. Each successive segmented lens section—each of which is either curved or planar—has an increasingly-negative gradient towards the edge of the cover arrangement 400. Such segmentation reduces the required thickness of the lens.

Still a further embodiment is shown in FIG. 12. Here, a cover member 400 over an active area 30 has an upper surface which is coated, laminated or otherwise formed from layers of material 405 having different refractive indices. The arrow A indicates the direction of increasing refractive index. The corner is also graded by, for example, dipping it into an active solution to diffuse into the material and change the refractive index. The index increases in the corner in the direction of the arrow B. Thus, a graded magnification is provided by means of differing refractive indices, without any geometric changes.

Various other arrangements will be apparent to the skilled person. For example, instead of, or in addition to, the use of a non-constant radius of curvature, or varying Fresnel lenses or graded refractive indices, multiple interfaces or air gaps could be employed. All that is necessary is that, overall, the rate of change of the local magnification is kept to a minimum across the lens.

Indeed it is not only desirable to maintain the rate of change of local magnification across a single lens at a minimum but it is also desirable to minimise the rate of change of local magnification across the junction between lenses of adjacent display panels. This is because, as a user moves from an on-axis viewing position to an off-axis viewing position, the viewed image across the two (or more) display panels may become distorted at the junction, as different magnifying regions of the display panels contribute to the viewed image. As a result, depending on the local magnification function across the join, the image may not be continuously viewable off axis, either because a section of the image disappears from view, or because a section of the image is duplicated on either side of the join.

It will be readily understood that this effect is especially evident with high-resolution desktop displays and for any applications in which a user may be situated relatively close to the displays.

FIG. 13 shows an embodiment of the present invention, in which the graded magnification of the cover arrangement edges of adjacent display panels does not extend all the way to the junction between the panels. The resulting magnification provided by the lenses 450, 450′ is illustrated schematically and exemplarily by the lens magnification function. Across the generally planar portion of the cover arrangements 400, 400′, the lens magnification is unity. Towards the edges of the cover arrangements 400, 400′, the lens magnification increases generally uniformly (exhibiting graded magnification) and at the edges, the magnification function is flattened and the lens magnification is constant. The image compression, provided either by hardware or software, preferably complements the optical magnification provided by the lenses 450, 450′, and an exemplary image compression function is schematically illustrated in FIG. 13. The contributing image compression graph, below the image compression function in FIG. 13, illustrates the parts of the active regions 30, 30′, which contribute to a viewed image across the two display panels when a user is on axis. Mainly, the repeated image regions 32, 32′, do not contribute to the viewed image. The lower contributing image compression graph illustrates those parts of the display which contribute to a viewed image when a user is off axis and to the right of the figure (i.e. somewhere generally above the cover arrangement 400′). In this case, a portion of the active display region 30 (between the schematic rays 72 and 73) does not contribute to the viewed image and this portion of the image is provided by the repeated image region 32′ instead. However, because this image portion when viewed on axis is magnified by substantially the same amount as the repeated image region 32′ when viewed off axis, distortion, omission or duplication of the viewed image as a user moves off axis is reduced.

As shown in FIG. 13, it is preferable for the portions of the active display regions 30, 30′, over which the image compression functions plateau to be at least the width of the repetition regions, 32, 32′, so that as the repeated image region begins to replace the portion of the displayed image which becomes obscured, a clear change in magnification is not observed. The width of the plateau of the lens magnification function preferably corresponds to the part of the image compression function plateau which contributes to a viewed image (i.e. lens magnification value×width of contributing image compression function plateau).

Preferably, for a viewed image to appear to be continuous across a junction between display panels, two conditions are fulfilled:

a) the value of the local magnification at both edges of the adjoining display panels remains equal across the viewing range; and

b) the integral of the local magnification across the magnifying width of the display panel edges remains substantially equal for on-axis and off-axis viewing positions.

These conditions may be fulfilled, either fully or in part, by providing flattened edges to the magnification and compression functions, or by providing negative slopes to the magnification and compression functions in a direction towards the junction. The complementary lens magnification function and image compression function may comprise straight sections, or these sections may be smoothed together, or these sections may be curved.

FIG. 14 shows a further embodiment of a cover arrangement, which exploits the fact that the rays emanating from the active area 30 do not pass through an optically-inactive region 5 of the cover arrangement 400. This region may therefore be used to house connectors, contacts and other functional materials and structures 92, without reducing the effectiveness of the display. This embodiment illustrates a touch-sensitive arrangement, having connections 91 around the edge of the cover arrangement and a touch-sensitive foil 90 laminated to the cover arrangement 400. Alternatively, materials could be laminated onto the cover member 400 to provide the touch-sensitive screen.

The cover arrangement 400 itself may be formed of different materials 41, 42, and 43, which may be laminated, or otherwise joined, together. Layer 41 may be formed of materials which improve the functionality of the active area 30; layer 42 may be formed of a material suitable for strengthening, or minimising the weight of, the arrangement; and layer 43 may be formed of a material suitable for achieving a desired optical interface.

FIG. 15 shows an alternative to the embodiment of FIG. 14, in which an additional material 44 is used to reduce the unevenness of the surface over two or more adjacent display panels and produce a substantially planar display screen. This embodiment facilitates the application of certain functional materials, such as an anti-reflective layer or a touch-sensitive material, to the cover arrangement 400. In this example, the material 44 preferably has a low refractive index—generally similar to that of air—so as not to reduce the effectiveness of the lens.

As discussed above, the structure and geometry of the region in which the light rays are bent preferably governs the particular manner in which the image is compressed. In order for a region with graded magnification to produce a desirable apparent image, the active area 30 of the display panel beneath this region is preferably arranged to display an image which includes graded compression. In addition, it is also preferable that the repeated image regions 32, which facilitate off-axis viewing, are compressed. Since these regions are relatively narrow, this compression may be uniform or graded.

Such image compression may be achieved, on the one hand, by using specifically designed software to produce a video signal of a suitably compressed image, or suitably to alter the data written to the graphics memory. On the other hand, electronic circuits may be used to manipulate the video signal, or the image stored in the graphics memory, to generate the desired image compression. The software alternative may be incorporated into a computer operating system or individual graphics drivers associated with the display arrangement; such software would then provide the ability to adapt to various display arrangements.

In embodiments employing one or more screen drivers, the purpose of the driver is to adjust the image or images which would otherwise be displayed using the display hardware, such that the image is displayed differently on the active area 30. The driver works by intercepting operating system calls sent to the underlying graphics hardware and modifying these calls before passing them down to the graphics hardware. The driver also intercepts and modifies information which is passed up from the hardware to the operating system and higher software layers. The driver generates a virtual screen area which is larger than the active area 30 provided by the display hardware. However, rather than providing vertical and/or horizontal scroll bars and giving a user the opportunity to scroll the larger image across the screen or to switch to another area of a larger desktop or work space, it is preferable for the entire image to be displayed on the screen at the same time. Therefore, the driver applies linear and/or non-linear transformations to the display image. The transformations are arranged to represent the inverse of the transformations produced by optical modification of the display image (e.g., magnification of the image) using the cover arrangement 400. In this way, the net result of the driver transformations and the optical transformations is that the image seen by a user is substantially undistorted. Because the virtual screen area of each display panel is larger than its respective active area 30, there appear to the operating system and the user to be display modes/resolutions which could not be achieved by additive combinations of the resolutions of the active areas provided by the display hardware, either with landscape or with portrait orientations of the displays.

The transformations are implemented through use of either the CPU of the system, the graphics hardware which forms part of the system, or additional, specialised graphics hardware. Transformations which may be performed include pixel blending, geometric modification, or video output modification: A pixel buffer (or pixel buffers) which corresponds to the size of the enlarged, virtual display may be copied to a buffer (or buffers) which corresponds to the size of the active area 30 of the display, transforming the pixels using a pixel blending algorithm. Depending on which areas of the image have been modified, the buffer (or buffers) may or may not be transformed one region at a time (so-called “dirty rectangle” updating). The pixel blending may be achieved by operation of either of the CPU or of graphics hardware, such as a consumer 3D graphics card. Alternatively, display primitives, such as lines, rectangles and curves may be geometrically modified before being drawn to the display buffer, thereby obviating the need for an extra buffer and copying operations. Alternatively still, a video output provided on the display panel may be modified to perform the required image transformations, rather than using operating system graphics operations. This may be achieved by interposing a separate item of video modification hardware between the image producing hardware and the display screen.

The hardware alternative may enable a display to accept a normal uncompressed video signal, therefore making the display compatible with most computer systems or imaging applications. Indeed, image manipulation may also be carried out using hardware such as, or in conjunction with, the LCD controller electronics, either in combination with or entirely without specific software, in order that the display uses one, or a number of, standard inputs. If used in combination with suitable software, the electronics may report the fact that the image to be displayed is of a greater resolution (i.e. number of vertical and horizontal lines of pixels, or any other number and distribution of pixels) than the resolution of the active area 30 of the display. If no specific software is being used (except for example a particular monitor driver) and, for example, the resolution corresponds to the entire display area, including inactive regions, the electronics may manipulate the incoming data so that the edges of the oversized image are compressed in a programmable manner, such that the resulting, warped image fits on to the active area 30 of the display.

Whether implemented in software, or in hardware, the compression may be varied electronically, either automatically or on request—and, if desired, under direct control—of the user, to adjust the display to suit the viewer's position. This embodiment may also be employed to compensate for the positioning of individual display panels, for example, if the panels are at an angle relative to one another.

FIG. 16 shows an embodiment of the present invention which may be used in an arrangement of display panels which are directed at a viewer or a group of viewers. The panels 100, 100′ are not co-planar, but angled, allowing near-perpendicular viewing of most of each panel. The cover arrangements 400 may be separate, laminated together, or formed from the same material to produce a flexible or rigid structure. The angle between the panels 100, 100′ influences the direction of the rays 73, so the compression is preferably adjusted to according to the angle. In addition, the direction of the viewed rays depends on the location of viewer(s). Any particular compression function will only suit a limited range of viewing positions, so the compression, the amount of image repetition, the image size and location relative to the active area 30 are preferably adjusted, either automatically, electronically or manually, to suit a desired viewing position.

One embodiment, which includes the adjustable compression discussed above, provides a display screen which may be used in at least two operational modes. In the first mode, the image compression function is turned off, so that the display screen has a visible border, which corresponds to the edge portion and the inactive region. Images are viewed through the planar portion of the cover member and are therefore neither compressed or magnified. This mode may, for example, be used by a single user with a single display panel, to prepare a presentation. In the second mode, the image compression functions are turned on, so that the apparent image extends fully across the display screen, the displayed image being compressed and then magnified, in the manner described above. This mode may, for example, be used to show the presentation to a group of viewers, using four display panels in a two-by-two arrangement, with the screen resolution being twice that of the image. This embodiment results in virtually no loss of image resolution at the panel edges, so that, for example, any text which was readable on the single panel in the first mode is also readable on the multiple-screen display in the second mode.

As will be appreciated, the apparently seamless viewing range of a multi-panel display is the combination of the apparently seamless viewing ranges from the edge, or seam, of each display panel 100. By arranging each lens 450 to have the above magnification functions for light exiting the display parallel to the plane of symmetry between two adjacent displays, and by providing a repetition region 32, 32′ either side of the junction, a generally wedge-shaped apparently seamless viewing range results for each junction. The seamless viewing range is symmetric about the plane of symmetry between the two adjacent displays. While preferable in certain applications, the symmetrical viewing range may not be necessary for other applications in which the apparently seamless viewing range in one direction is of greater importance than that of the other direction. One such example is an application of present invention in a wall-mounted display, where the display is relatively vertically higher than its viewers. In this case, the apparently seamless viewing range is preferably adjusted for the range of viewing positions of viewers on the ground. This may be achieved by arranging the lens profiles such that they exhibit an optimised magnification function for light rays directed generally within the viewing range of such viewers (i.e. for a viewing line which is at an angle with respect to the ground, or horizontal). This, in turn, may be achieved by adjusting the position of adjacent lenses 450, 450′, such that the lenses do not both cover the same proportion of the inactive region between adjacent displays, but are moved in the direction of the extended viewing angle (here towards the ground) with respect to the displays. In other words, the lens layers 450, 450′ are offset downwardly with respect to the displays.

FIG. 17 shows a display panel 100 with schematic rays 72-74 for an off-axis viewing position. When an image is viewed from an on-axis position, the graded magnification of the lens 450 reduces the appearance of a seam at the edge of the display panel. As a viewing position is moved from a normal to the display panel 100, at a certain viewing angle (approximately 15° to the normal), it becomes no longer possible for the schematic rays 72 emanating from the active display area 30 and the repeated image region 32 to continue to be redirected towards the viewing position from substantially the whole area of the cover arrangement 400. That is, for viewing angles greater than approximately 15°, schematic rays which would reach the viewing position from the edge of the cover arrangement 400 are rays 73 and 74, but since no image is actually displayed from the inactive display area 33, an imageless seam appears towards the edge of the display panel 100. The apparent image therefore fails to extend as far as the edge of the display panel 100. The region between rays 73 and 74 is seen as a dark or inactive area by a user.

FIG. 18 shows an embodiment of the present invention which overcomes the problem of the dark region appearing at the edge of the display panel 100 and maintains the apparent seamlessness of a viewed image. The display panel 100 has an optically unused area 5, which extends from the display area to the edge of the cover arrangement 400. A surface or interface 55 bounds the optically unused area 5, from an edge of the repeated image region 32 to an edge of the cover arrangement 400. The interface 55 is arranged to be reflective, such that light rays emanating from the active display (either from the active display area 30 or the repeated image region 32) and incident upon the interface are reflected and appear to originate therefrom. In FIG. 18, schematic ray 74′ is produced in the repeated image region 32, reflected at the reflective interface 55 and refracted by the lens 450, to form a region between rays 73 and 74′ which is a mirror image of that produced by the repeated image region. As a user moves even further off axis, this mirror image strip becomes wider as parts of the image from the active display area 30 are also reflected by the reflective interface 55. In this way, an increasing proportion of the apparent image is a mirror image of that displayed by the display area 30, during which the inactive area 33 and optically unused region 5 remain unobserved.

As will be apparent, the mirror image is a back-to-front representation of the image displayed by the active display area 30 or the repeated image region 32. As such, this embodiment finds particular application where displayed image details, the sizes of which are of the order of the mirrored region, are not essential to the understanding of the image. The advantage of the mirrored image strip is that it is of the same or similar colour to the image adjacent the strip and will therefore camouflage the seam or seams furthest away from a user, over a relatively wide viewing range. The embodiment thus improves the general appearance of an image at a distance, in particular in a tiled array of display panels 100, such as a video wall used for advertising or a mobile advertising display fitted to the roof of a taxi, for example. The use of the reflective surface 55 permits an increase in the apparently seamless viewing range from around 15° to approximately 45°, for display panel edges furthest from the viewer. The apparently seamless viewing range of display panel edges closest to the viewer may also be increased by bonding the cover arrangement 400 and the display together, to remove the air gap otherwise formed therebetween.

The reflective surface 55 may be provided without the need to use additional materials, although these may be included to increase the range over which the surface reflects light. The reflective surface 55 may be milled into the lens material 450 to produce an angled edge or a large edge chamfer if required. For example, for attachment purposes, the cover arrangement 400 may be extended to its original shape by bonding further material onto this reflective surface 55. In order for the surface 55 to remain reflective in such an arrangement, there is required a sufficient change in refractive index at the surface. Alternatively, an air gap or a reflective material may be interposed between the surface 55 and the extra material before bonding. Depending on the particular application, one or more edges of the display panel 100 may include a reflective surface 55, to extend the viewing angle in a direction normal to the edge or edges. For example, if a display panel (or panels) is mounted generally at head height and intended to be viewed by passers-by, the viewing ranges for the top and bottom edges of the display panel 100 may not need to be extended. Accordingly, only the vertical (i.e. the left and right) edges of the display panel 100 would include a reflective surface 55.

FIG. 19 shows an embodiment in which a relatively thinner lens 450 is used with a reflective surface 55. This embodiment may be used, in particular, in situations where viewers are sufficiently far away from the display panel 100 that relatively lower resolution images may be shown on the display. As such, mirroring of individual pixels, for example, does not result in an appreciable difference in an image observed by a viewer. A relatively large proportion of the image may therefore be mirrored by the reflective surface 55 without an appreciable loss in the viewed image quality. In addition, the size of the repeated image region 32 may be reduced and, in some cases, not used at all. Furthermore, the reflective surface 55 may be arranged to reflect parts of the displayed image, even during on-axis viewing. A reduction in the thickness of the cover arrangement 400 is thereby permitted (from surface 47 to surface 47′). Indeed, for certain applications, the requirements for the quality of a displayed image may be sufficiently relaxed (i.e. the displayed resolution may be relatively low) that the magnifying function of the edge of the lens 450 may be reduced. In other words, the extent to which the edge of the lens 450 exhibits graded magnification may be less than in embodiments not using reflective surface 55.

FIG. 20 shows the extreme case of the magnifying function having been reduced substantially to zero. The cover arrangement 400 is generally planar and the only significant cause of light bending by the display panel is the reflective interface 55.

In embodiments employing projection displays, the preferable graded image compression may be achieved optically, using suitable light bending structures. The advantage of this is that the alignment of a projector may be simplified, since the compressed image is always aligned with the magnifying portion of the cover arrangement 400. Adjustment of this optical image compression may be achieved, for example, with electronically controlled optical materials or by mechanically moving optical structures. FIG. 21 shows a cross-section through the edge of a projection system, with light rays 76, 77 generating the apparent image on the illuminated display area 30, onto which the viewer's eye focuses. The outermost rays 77 pass through a region 25 which bends these light rays and compresses the image optically, in any suitable manner known in the art, and compressed rays 78 emerge from this region. These rays 77, 78 may include repeated sections of images from adjacent panels, in order to increase the viewing angle. FIG. 21 also shows some of this light being redirected into the edge of the cover arrangement 400 (as indicated by ray 75). This is preferable to reduce the appearance of the seam and is discussed in more detail below.

FIG. 22 shows a highly schematic embodiment of graded optical compression. Rays 77 pass through a lens 26 and are bent in the required direction. The shape and optical properties of the lens 26 determine the degree of the image compression. Such compression is preferably aligned with the magnification and independent of the projector alignment.

Although the present invention minimises off-axis distortion and reduces the drop in resolution towards the edge of the screen, with embodiments which employ a combination of graded image compression and graded optical magnification, the apparent image includes regions having a changed resolution and modified pixel shapes and sizes. For example, pixels near a cover member edge are stretched in a direction perpendicular to that edge; that is, pixels along the top or bottom edges are stretched vertically and those along the edge on either side are stretched horizontally. At the corners the pixel size increases in both directions. Although still relatively low, this loss of resolution may be highest in the immediate proximity of an edge. In such embodiments, very small fonts may become less readable. It is therefore preferable to alter these images, either using software, or hardware. Software may be used to render the images so that they are more suitable for any particular display. Specifically, certain fonts may be adjusted to suit their location on the active area 30. Alternatively, hardware and software may be used to determine which parts of an image in the region of compression include text, for example, and render the text in an optimised way for the particular pixels on which they are to be displayed, taking into account the apparent pixel sizes, shapes and positions relative to one another. Enhancing the quality of an image in these embodiments is preferably only performed on those parts in or near the magnifying, edge region of the cover arrangement 400.

The image compression is adjustable either manually or automatically. For example, where a plurality of abutting display panels are employed, the appearance of text or images adjacent the join between each will be more or less distorted, for a given form of cover assembly edge and active display area, depending upon the relative angle between the viewer and the panels, personal preferences of the viewer(s) and so forth. It may, therefore, be desirable to have a dial, for example, similar to the brightness/contrast wheel on laptop computers, to allow manual adjustment (via software) of the image compression at the edge of the active display areas.

FIG. 23 shows a further embodiment of the present invention, in which two panels 100 and 100′ abut each other, forming a thin dark seam 60. Next to, or intersecting with, the magnifying, edge portion 2, there is a light-coupling region 6, which couples light into the edge of the panels 100, 100′, or into the gap between them. The rays 74, which emanate from the active area 30 but do not reach the top surface of the cover arrangement 400, are very close to, or exactly, the colour which it is preferable to substitute for the otherwise dark seam 60. This light 74 may be redirected through the seam 60 towards the viewer, so as to reduce the appearance of the seam. The light may be redirected into either the gap between, or the edges of, the cover arrangements 400 by using refraction, diffraction or reflection in any suitable way. Optical foils, half mirroring and microstructures may be incorporated into the edge of the cover arrangement, and, in addition, the optically-inactive region 5 of FIG. 14 may house optical features to this end. Other, still more straightforward approaches may be taken to address the dark seam. For example, an index matching or other gel, silicone rubber, or any other translucent, flexible, plastic material may be placed along the seams. Indeed, petroleum jelly smeared along each seam reduces the appearance of the black line.

This embodiment enhances the image quality in the region of the join between display panels 100, 100′, if the cover arrangements 400, 400′ are not one continuous structure, for example if the covers need to be able to move relative to one another. Fabrication and material constraints, as well as wear and foreign substances result in a non-ideal joint. The region in which the edges are rounded and not perfectly sharp, as well as the air-gap between the two cover arrangements, would otherwise appear as an inactive dark seam to the viewer. It will be understood that most of the redirected light 75 would be lost inside the display, if it were not bent within the light-coupling region 6 towards the direction of the viewer.

FIG. 24 shows a second embodiment having a light-coupling region 6. The two adjacent panels 100, 100′ are separated by a thin air gap and both contain a light-coupling region 6, 6′. The seam 60 is not illuminated by the active areas 30, 30′ directly, but the ambient rays 74, 74′, which would otherwise remain unused, are redirected into the air gap and then bent towards the direction of the viewer, generally perpendicular to the panels 100, 100′. In the depicted embodiment, rays 74, 74′ from the active areas 30, 30′ are refracted at interfaces 61, 61′ and then reflected at interfaces 62, 62′, after which the light propagates upwards through the gap. In this embodiment, the incident ray angles alone determine whether reflection or refraction takes place. Of course, other suitable materials may be used to differentiate and localise refraction and reflection.

A further embodiment of the present invention (not shown) includes means suitable for reducing the variations in the brightness of a viewed image. When an image is magnified or when light has to pass through a number of interfaces or different materials, the light intensity may be reduced. In some cases, therefore, a cover arrangement exhibiting graded magnification may cause a drop in luminosity. In addition, ambient light may result in shadows appearing within the display. This is particularly so in embodiments using non-transmissive displays, for example, reflective LCDs, in which the edge regions of the cover arrangement 400 may cast shadows onto the active area 30. This embodiment compensates for any reduction in luminosity and any shadows by adapting the brightness of the image. This may be done firstly by using software or hardware, to change the image signal to be displayed, so that a brighter image is produced at locations where there is a known drop in luminosity. Secondly, using hardware alone, either in addition to, or as a modification of, existing equipment or hardware, the brightness of the image may be corrected. Thirdly, the back-light may be adapted to produce uneven lighting which compensates for the changes in luminosity. This may be achieved, for example, by increasing or reducing the local reflection or absorption of light, either at the surface of a light guide, or by forming a separate inhomogeneous layer, or by arranging a non-uniform light source.

A further embodiment to reduce the visual impact of the inactive border which appears once a critical viewing angle has been exceeded, involves the colour of the optically-inactive region being changed, either permanently or temporarily, from black to a lighter, less obvious colour.

In some applications of the present invention, the thickness of the cover arrangement 400 is not of particular concern from a functionality point of view (ignoring factors such as cost and ergonomics). However, in other applications, such as mobile or portable applications, the thickness of the cover arrangement 400 may be a limiting factor. This thickness is a strong function of the width of the inactive area of the display, which requires disguising. If the width of the inactive area 33 can be reduced, then a corresponding reduction in the cover arrangement thickness may also be achievable. In the case of transmissive displays, a light source located at the edge of a display injects light into a translucent plate behind the display. This translucent plate radiates the light evenly throughout the display. As such the inactive region 33 contains electronics, light source connectors and the like. A number of ways of reducing the width of the inactive area 33 are known. A further, advantageous way to achieve this involves combining the light guides located on either side of a junction between adjoining panels. In this way, a single light guide may be used to emit light into both panels on either side of it. A saving of the width of one light guide is thereby provided. This can be taken to the extreme by using the light emanating from one translucent plate to feed the adjacent plate. Then there is no need for any additional light guides at all. This can be advantageous for portable two-part displays because then only one display half contains active back-lighting.

FIG. 25 and onwards show exemplary applications of the present invention.

FIG. 25 shows an exploded view of an embodiment of the present invention having a seamless display panel. In practice, the cover arrangement 400, consisting of the planar portion and the lens, and any optical films or a touch sensitive cover, and the display panel, consisting of an LCD display and driver electronics, are mounted together to form a suitably thin display; on which an image may be seen fully extending to the edge with no apparent inactive border. This basic unit may then be tiled in a variety of ways, to form planar or non-planar displays, and displays which are movable relative to one another, as exemplified in the following figures.

FIG. 26 shows a multiple-screen viewing system, using tiled apparently-seamless panels. Such a system would be suitable for computer simulation, command and control centres, computer games, trading desks and many other applications. The panels may be modular, so as to permit the addition of additional screens, or the adjustment of angles between screens. Alternatively, the panels may be mounted into one rigid frame. Such a system would also benefit from being able to adjust the compression and image size or location, in order to suit the position of the users.

FIGS. 27a, 27b show an application of the present invention in a portable device. In portable devices, a number of panels may be arranged either so that they fold out into a large display, or, as depicted here, so that they slide relative to one another and move into place to form a large seamless display. In the closed position in FIG. 27b, the two panels are parallel with one behind the other but each facing forwards as seen in the Figure. In the open position of FIG. 27a, the displays are adapted to snap into the same plane.

FIG. 28 shows an application in which a large number of panels are arranged into a data wall or video wall. Any configuration is possible, with individual panels having any number of edges—from zero to four—in common with the entire display. For some applications it is preferable to angle panels relative to one another.

FIG. 29a shows an angled arrangement in more detail. A large number of flat panels may be used to create curved seamless displays. FIG. 29b shows an application in which curved or flexible displays, having a curved or flexible active area 300, may be arranged to follow a curve more closely than with flat panels. In this case, the panels 100 may be rigid and flat, or rigid and curved, or flexible.

FIG. 30 shows an embodiment of the present invention which comprises a modular display panel arrangement. The display panel 100 comprises a conventional substrate 20, along with an active display area and the like, and an attachable cover arrangement 4000. The attachable cover arrangement 4000 comprises the lens layer 450 and any other suitable layer or layers 420, and includes attachment means 425, for fitting the attachable cover arrangement to the display. The attachment means 425 may comprise clips, hooks, or the like, or may comprise semi-permanent or permanent attachment fittings.

Preferably, the cover arrangement layer 420 is hollow, thereby reducing the weight of the attachable cover arrangement 4000 significantly and providing the option of manufacture by moulding processes.

FIGS. 31a and 31b show an arrangement of three modular display panels 100 in a linear array. Any number of such display monitors may be arranged in a line of n×1 monitors or a matrix of n×n monitors, to form a seamless display.

FIG. 32 shows an embodiment of the present invention, in which a number of displays are arranged at an angle with respect to each other. Instead of providing a cover arrangement 400 which extends fully across a display, a partial cover arrangement, provided by a lens 455, is provided. The lens 455 extends generally across the edge regions of two adjacent displays and fits in the angled, concave junction between the displays (and thus has a generally triangular cross section). Of course, the cross section of the lens 455 may take any suitable form.

FIG. 33 shows three examples of suitable lens arrangements for two-panel angled display applications. In example (a), lens 455 extends substantially across both displays (not shown) and the “actively” refracting portion of the lens is the rear (curved) surface, which faces the displays. In example (b), lens 455 extends only partially across the displays (not shown) and the “actively” refracting portion of the lens is again the rear surface. In example (c), lens 455 again does not extend fully across both displays (again not shown), and the “actively” refracting portion of the lens is the front (curved) surface, which faces away from the displays. The lens 455 shown in FIGS. 32 and 33 may be arranged to be optimized for a viewer positioned along a line which bisects the two, adjacent displays, as illustrated by schematic rays 72 in FIG. 32. In this way, the effectiveness of masking the seam between the displays may be advantageously increased. It will appreciated that, as well as with angled desktop displays, partially extending lens 455 may also be of benefit with applications using flat, low-resolution displays.

Various other embodiments will be apparent to those skilled in the art.

1. A visual display screen arrangement for displaying an image, comprising:
image display means having a display area; and
a translucent cover member arranged to cover the display area and having a first cover member edge, the display area having an edge extending towards but not as far as the said first cover member edge, the cover member providing a local magnification defined as the ratio of the apparent magnitude of an area A of the display area, as viewed through the cover member at a particular angle of incidence, to the actual magnitude of that area A within the display area;
the cover member having:
(a) a generally planar portion covering at least a part of the display area and being arranged to transmit parallel rays of light emanating from different locations across the display area such that they are bent by substantially the same angle when viewed externally of the arrangement and wherein the local magnification is substantially unity; and
(b) an edge portion which includes the first cover member edge, the said edge portion having a light bending region arranged to bend rays of light emanating from different locations at or adjacent to the edge of the display area such that the said display area, as viewed externally of the arrangement and through the edge portion, appears to extend substantially as far as the edge of the cover member,
characterised in that the light bending region of the edge portion provides a local magnification which varies with distance from the cover member edge, and wherein the light bending region has a graded magnification adapted to minimize the rate of change of local magnification between the generally planar portion of the cover member and the first cover member edge.

2. The arrangement of claim 1, wherein the light bending region includes a graded refractive index and/or a non-constant curvature so as to provide for a graded magnification of an area within the display area.

3. The arrangement of claim 1, wherein the light bending region comprises a curved section, the radius of curvature thereof being non-constant so as to minimize the said rate of change of local magnification.

4. The arrangement of claim 1, wherein the light bending region has a graded refractive index so as to minimize the rate of change of local magnification.

5. The arrangement of claim 1, wherein the light bending region is a segmented lens having a graded magnification.

6. The arrangement of claim 1, wherein the cover member further includes a second cover member edge which is generally orthogonal to the said first cover member edge, the cover member also having a further edge portion including a second light bending region and the said second cover member edge, wherein the second light bending region of the further edge portion also provides a local magnification which varies with distance from the second cover member edge and wherein the second light bending region also has a graded magnification adapted to minimize the rate of change of local magnification between the generally planar portion of the cover member and the second cover member edge.

7. The arrangement of claim 6, wherein the translucent cover member has further sides at least one of which has a cover member edge portion containing a further light bending region and a further cover member edge, and wherein each such further side having the further light bending region has a graded magnification so as to minimize the rate of change of local magnification between the planar portion of the cover member and the cover member edge of that side.

8. The arrangement of claim 1, wherein the image display means is arranged to display an image which is compressed adjacent to or near the display area edge.

9. The arrangement of claim 8, wherein the image display means is arranged to generate a graded compression of the image.

10. The arrangement of claim 9, wherein the graded compression of the image complements the graded magnification provided by the edge portion of the cover member such that an image, as viewed externally of the arrangement, appears substantially undistorted.

11. The arrangement of claim 8, further comprising a processor arranged to process an image to be displayed within the display area so as to provide compression thereof.

12. The arrangement of claim 8, wherein the image display area comprises a plurality of pixels, the area covered by a pixel in a first region adjacent to the said edge of the display area being different to the area covered by a pixel in a second region beneath the generally planar portion of the cover member, and wherein the magnitude of the area of the pixels is graded between the said first and second regions.

13. The arrangement of claim 8, further comprising an image compression adjuster, operable to alter the compression of an image in the vicinity of the edge of the image display area.

14. The arrangement of claim 13, wherein the image compression adjuster is manually operable.

15. The arrangement of claim 13, wherein the image compression adjuster is operable under software control automatically to adjust the image compression in the vicinity of the edge of the image display area.

16. The arrangement of claim 15, wherein the image compression adjuster is arranged to detect the presence of text in a region adjacent the edge of the image display area, and automatically to adjust the font size and/or shape in that region so as to improve the legibility thereof.

17. The arrangement of claim 1, further comprising light coupling means, arranged adjacent the edge of the cover member and adapted to couple light emanating from the image display area through the said edge of the cover member.

18. The arrangement of claim 17, wherein the light coupling means is incorporated into the edge of the cover member and is an optical foil or a half mirror.

19. The arrangement of claim 17, wherein the light coupling means is formed upon the edge of the cover member and is selected from the list comprising a gel such as an index matching gel, silicone rubber and petroleum jelly.

20. The arrangement of claim 1, further including brightness detection means arranged to determine the uniformity of brightness of an image within the image display area, and brightness adjustment means to compensate for detected brightness variations within a displayed image.

21. The arrangement of claim 20, wherein the arrangement includes a backlight to illuminate the image display area, the brightness adjustment means includes a controller arranged to adjust the intensity of the backlight in dependence upon the detected brightness variations.

22. The arrangement of claim 1, further comprising:
second image display means having a second display area; and
a second translucent cover member arranged to cover the second display area, the second cover member having a first cover member edge locatable in use adjacent the first cover member edge of the first cover member, the second display area having an edge extending towards but not as far as the said first cover member edge of the second cover member, the second cover member providing a local magnification, defined as the ratio of the apparent magnitude of an area A′ of the second display area as viewed through the second cover member at a particular angle of incidence, to the actual magnitude of that area A′ within the second display area;
the second cover member having:
(a) a generally planar portion covering at least a part of the second display area and being arranged to transmit parallel rays of light emanating from different locations across the second display area such that they are bent by substantially the same angle when viewed externally of the arrangement; and
(b) an edge portion which includes the first cover member edge, the edge portion of the second cover member having a light bending region arranged to bend rays of light emanating from different locations at or adjacent to the edge of the second display area such that the second display area, as viewed externally of the arrangement and through the edge portion of the second cover member, appears to extend substantially as far as the first cover member edge thereof,
wherein the light bending region of the edge portion of the second cover member also provides a local magnification which varies with distance from the cover member edge, and wherein the light bending region thereon has a graded magnification adapted to minimize the rate of change of local magnification between the generally planar portion of the second cover member and the first cover member edge thereof.

23. The arrangement of claim 22, further arranged to generate at least a part of an image both within the first display area and adjacent the first cover member edge and also within the second display area, adjacent the first cover member edge of the second cover member.

24. The arrangement of claim 22, wherein the second image display means and the second translucent cover member are moveable relative to the first image display means and the first translucent cover member, between a first, open position wherein the edges of the cover member edge portions of the first and second cover members abut one another, and a second, closed position wherein the said edges of each cover member edge portion do not abut one another.

25. The arrangement of claim 22, wherein the first and second light bending regions having graded magnifications further comprise respective first and second magnification transition portions located towards the first and second cover member edges respectively, the first and second magnification transition portions both providing a substantially constant and equal local magnification, such that an image displayed by the first and second display means appears substantially undistorted across a junction therebetween as a user moves away from a viewing position generally above the junction to one side.

26. The arrangement of claim 22, wherein the first and second light bending regions having graded magnifications further comprise respective first and second magnification transition portions located towards the first and second cover member edges respectively, the first and second magnification transition portions providing a generally decreasing local magnification towards the respective first and second cover member edges, such that an image displayed by the first and second display means appears substantially undistorted across a junction therebetween as a user moves away from a viewing position generally above the junction to one side.

27. The arrangement of claim 25, wherein the first and second image display means are arranged to generate a compression of the image which corresponds to the magnification provided by the first and second light bending regions having graded magnification and respective first and second magnification transition portions.

28. An image display assembly comprising a plurality of visual display screen arrangements as claimed in claim 1.

29. The image display assembly of claim 28, wherein each arrangement abuts another such arrangement so as to provide a tessellated assembly.

30. A mobile telephone; a personal digital computer; a command, control or gaming console; or other fixed or portable, single-screen or multi-screen device, -comprising the arrangement of claim 1.

31. (canceled)
